(19) United States
(12) Patent Application Publication
(10) Pub. No.: US 2026/0093043 A1
(43) Pub. Date: Apr. 2, 2026

(54) WI-FI POSITIONING WITH GNSS RAY TRACING

(71) Applicant: Apple Inc., Cupertino, CA (US)

(72) Inventors: Saajan Dhir, Cupertino, CA (US); Adam R. Bhavnani, Sunnyvale, CA (US); Chun-Yuan Yang, Saratoga, CA (US); Jasmin Desai, San Jose, CA (US)

(21) Appl. No.: 19/341,724

(22) Filed: Sep. 26, 2025

Related U.S. Application Data
(60) Provisional application No. 63/700,603, filed on Sep. 27, 2024.

(51) Int. Cl. G01S 19/22

(52) U.S. Cl. CPC G01S 19/22

(57) ABSTRACT

Disclosed are methods, systems, and computer-readable medium to perform operations including: generating a ray trace between a device and a global navigation satellite system (GNSS) satellite, where the ray trace includes a reflection off of at least one object; determining, based on the ray trace, a context for a position of the device; and determining the position of the device based on the context and information associated with an access point detected by the device.

### CROSS-REFERENCE TO RELATED APPLICATIONS

This application claims priority to and the benefit of U.S. Provisional Patent Application No. 63/700,603, filed September 27, 2024, the entire contents of which is incorporated herein by reference.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “Wi-Fi”). A WLAN typically includes an access point that provides one or more stations (STAs) with access to another network, such as the Internet. There are many generations of the IEEE 802.11 standard, including 802.11ax (Wi-Fi 6) and 802.11be (Wi-Fi 7). Wi-Fi can also be used for positioning by, for example, leveraging the signals from nearby access points to estimate a device’s location.

### SUMMARY

The present disclosure describes techniques for improving the accuracy and precision of positioning, such as Wi-Fi positioning, by leveraging global navigation satellite system (GNSS) ray tracing. In some examples, when a GNSS signal is received by a device, simulated ray traces are generated that originate at the device and reflect off modeled objects (e.g., buildings) en route to the satellite. If a valid ray tracing path is found, contextual information from the ray trace, such as the point or surface of reflection, can be used to refine the device's estimated position. When combined with Wi-Fi positioning, this contextual information can reduce the effective radius of an access point (AP), which can shrink the zone of uncertainty. In some examples, the contextual information may support excluding an AP entirely from the location calculation to improve accuracy.

In general, in a first aspect, a method includes: generating a ray trace between a device and a GNSS satellite, the ray trace including a reflection off of at least one object; determining, based on the ray trace, a context for a position of the device; and determining the position of the device based at least on the context and information associated with an AP detected by the device.

In a second aspect combinable with the first aspect, the method includes: receiving an estimated position of the device; accessing object data specifying one or more objects within a predetermined distance of the estimated position of the device; generating a plurality of ray traces from the estimated position of the device to a GNSS satellite, where each of the plurality of ray traces reflects off of at least one of the one or more objects; and selecting, from the plurality of ray traces, the ray trace that connects the device and the GNSS satellite.

In a third aspect combinable with the first or second aspects, the estimated position of the device is based at least on the information associated with the AP.

In a fourth aspect combinable with any of the first through third aspects, the method includes: determining a position of the GNSS satellite; and selecting the ray trace that connects the device and the GNSS satellite by selecting, from the plurality of ray traces, a ray trace connecting the estimated position of the device and the position of the satellite.

In a fifth aspect combinable with any of the first through fourth aspects, the position of the GNSS satellite is determined from a signal received from the GNSS satellite.

In a sixth aspect combinable with any of the first through fifth aspects, the object data includes three-dimensional building data, and where at least one of the one or more objects includes a building or infrastructure.

In a seventh aspect combinable with any of the first through sixth aspects, the ray trace represents a signal path of a signal received by the device from the GNSS satellite.

In an eighth aspect combinable with any of the first through eighth aspects, the context includes at least one of: a point of a reflection of a signal from the GNSS satellite off of the at least one object, a surface of the at least one object associated with a reflection of the signal from the GNSS satellite, or a direction of arrival of the signal from the GNSS satellite at the device.

In a ninth aspect combinable with any of the first through eighth aspects, the method includes: receiving position data specifying a position of the AP; and determining the position of the device based at least on the context and the position of the AP.

In a tenth aspect combinable with any of the first through ninth aspects, where the AP is associated with a region representing a possible position of the device, the method including: adjusting, based on the context, the region associated with the AP; and determining the position of the device based at least on the context and the adjusted region.

In an eleventh aspect combinable with any of the first through tenth aspects, the region includes a region defined by a radius surrounding a centroid associated with the AP.

In a twelfth aspect combinable with any of the first through eleventh aspects, the radius is determined based on a strength of a signal received by the device from the AP.

In a thirteenth aspect combinable with any of the first through twelfth aspects, adjusting the region includes removing at least a portion of the region.

In a fourteenth aspect combinable with any of the first through thirteenth aspects, the context includes a surface of the at least one object associated with the reflection, and where the at least the portion of the region is removed based on the surface.

In a fifteenth aspect combinable with any of the first through fourteenth aspects, the method includes: excluding, based on the context, a region associated with at least one other AP when determining the position of the device.

In a sixteenth aspect combinable with any of the first through fifteenth aspects, the method includes: including, based on the context, a region associated with at least one other AP when determining the position of the device.

In a seventeenth aspect combinable with any of the first through sixteenth aspects, the method includes: identifying a surface of the at least one object associated with the reflection; and removing at least a portion of the region based on the surface.

In an eighteenth aspect combinable with any of the first through seventeenth aspects, determining the position of the device based at least on the context and the adjusted region includes determining the position of the device within the adjusted region.

In a nineteenth aspect combinable with any of the first through eighteenth aspects, determining the position of the device based at least on the context and the adjusted region includes determining the position of the device based on an intersection among the adjusted region and at least one other region associated with at least one other AP detected by the device.

In a twentieth aspect combinable with any of the first through nineteenth aspects, the AP includes a Wi-Fi AP.

In a twenty-first aspect combinable with any of the first through twentieth aspects, the device is a mobile device.

In a twenty-second aspect combinable with any of the first through twenty-first aspects, the method is performed by the device.

In a twenty-third aspect combinable with any of the first through twenty-second aspects, the method is performed by one or more processors.

In general, in a twenty-fourth aspect, a non-transitory computer-readable storage medium is encoded with instructions that, when executed by one or more processors, cause the one or more processors to perform the method of any of the first through twenty-first aspects.

In general, in a twenty-fifth aspect, a system includes one or more processors and one or more storage devices storing instructions executable by the one or more processors to perform the method of any of the first through twenty-first aspects.

In general, in a twenty-sixth aspect, a device includes one or more processors and one or more storage devices storing instructions executable by the one or more processors to perform the method of any of the first through twenty-first aspects.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a block diagram of example of electronic devices communicating wirelessly, according to some implementations.

FIG. 2 illustrates an example of Wi-Fi positioning, according to some implementations.

FIGS. 3A-3C illustrate examples of Wi-Fi positioning with global navigation satellite system (GNSS) ray tracing, according to some implementations.

FIG. 4 illustrates a flowchart of an example method for Wi-Fi positioning with GNSS ray tracing, according to some implementations.

FIG. 5 illustrates a block diagram of an example electronic device for Wi-Fi positioning with GNSS ray tracing, according to some implementations.

### DETAILED DESCRIPTION

The position of an electronic device can be useful for applications such as navigation, location-based services, and emergency response, among others. One technique used to estimate the position of an electronic device is Wi-Fi positioning. In general, Wi-Fi positioning leverages the known positions of nearby Wi-Fi access points (APs) to estimate the position of a device. Initially, the device performs a scan to detect AP(s) within a range of the device. If the device detects an AP, then it is assumed that the device is within a radius that surrounds a centroid associated with the AP. When several APs are detected, the position of the device can be estimated as the geometric intersection among the radii of each AP.

However, Wi-Fi positioning can be prone to positioning errors and high positioning uncertainty. For example, because AP signal strengths can vary significantly over time due to, e.g., interference and obstructions, the radius associated with a particular AP may not accurately reflect the true radius at the time of the scan. As such, estimating the position of the device based on the radius can result in errors. In addition, there may be multiple (or missing) intersections among the radii of different APs, which can lead to a high level of uncertainty in the position estimate.

The techniques described herein leverage global navigation satellite system (GNSS) ray tracing to improve the accuracy and precision of positioning. In some examples, when a GNSS signal is observed by a device, a set of simulated ray traces is generated that originate at the device and reflect off at least one modeled object (e.g., a building or other infrastructure) in transit toward the GNSS satellite. If a successful ray tracing solution between the device and the satellite is identified, the ray trace can be used to inform the positioning estimate. For example, contextual information derived from the ray trace, such as information about the point or surface of reflection, can be used to inform the location of the device. When the techniques are used in conjunction with Wi-Fi positioning, ray tracing can help refine the location of the device within an AP’s radius, effectively reducing the AP’s radius and the corresponding zone of uncertainty. As another example, contextual information derived from the ray trace may be used to exclude an AP entirely from use in deriving the position estimate, e.g., in order to produce a more accurate estimate based on the one or more remaining APs. By using GNSS ray tracing to inform Wi-Fi positioning (or other location determination methodology), the uncertainty and inaccuracies associated with standalone Wi-Fi position measurements can be reduced, resulting in a better position estimate overall. Similarly, GNSS ray tracing can be used to improve location determination based solely on GNSS signals.

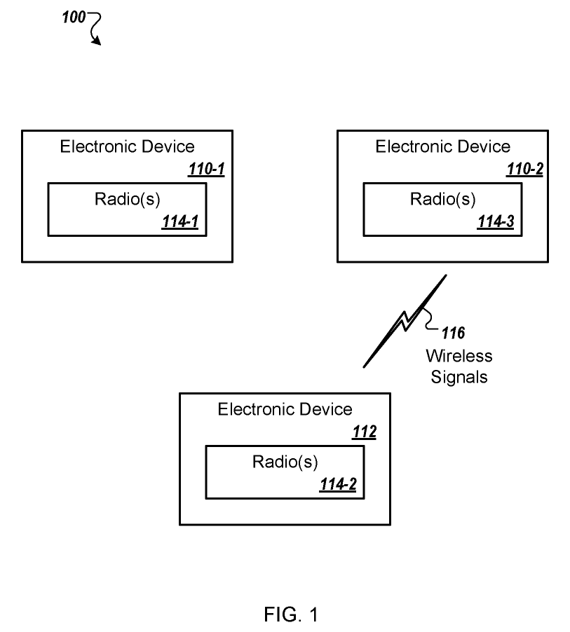

FIG. 1 illustrates a block diagram 100 of an example of electronic devices communicating wirelessly, according to some implementations. Notably, one or more electronic devices 110 (such as a smartphone, a laptop computer, a notebook computer, a tablet, a wearable, or other such electronic devices) and access point 112 can communicate wirelessly in a WLAN using an IEEE 802.11 communication protocol. Thus, electronic devices 110 can be associated with, or can have a connection with, access point 112. For example, electronic devices 110 and access point 112 can wirelessly communicate, including detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data payloads). Note that the access point 112 can provide access to a network, such as the Internet. Access point 112 can be a physical access point or a virtual or “software” access point that is implemented on a computer or an electronic device. In this specification, electronic devices 110 are sometimes referred to as “recipient electronic devices” or “receiver stations.”

Although the environment shown in FIG. 1 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between electronic devices 110.

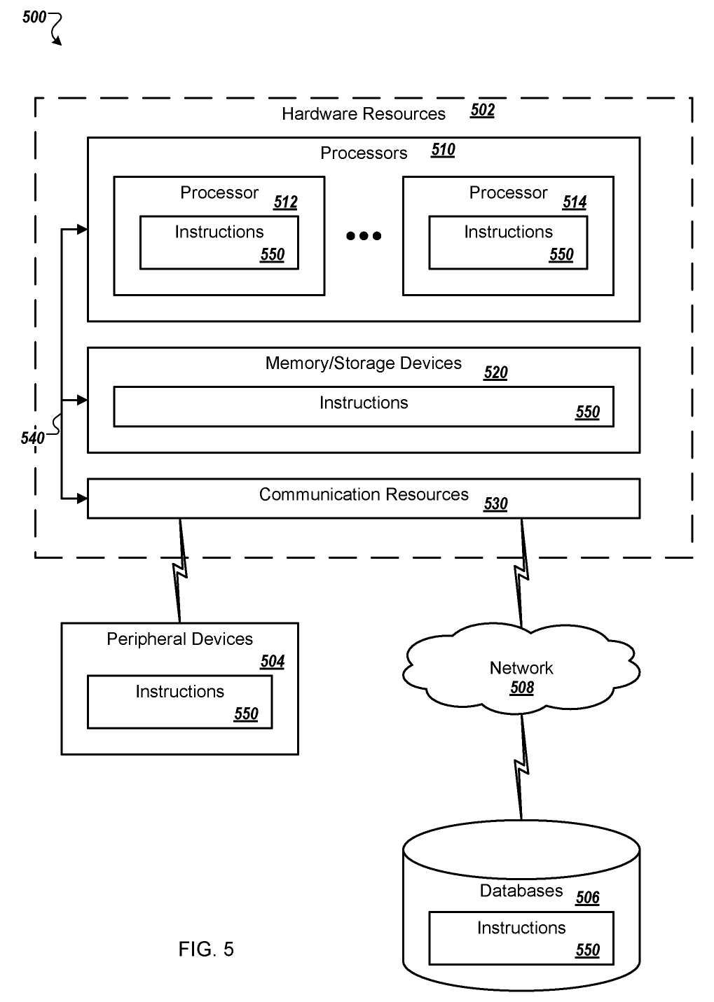

As described further below with reference to FIG. 5, electronic devices 110 and access point 112 can include one or more subsystems, such as a networking subsystem, a memory subsystem, and/or a processor subsystem. In addition, electronic devices 110 and access point 112 can include one or more radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in electronic device 110-1 and access point 112, respectively. For example, as noted previously, electronic device 110-1 and access point 112 can exchange packets or frames using a Wi-Fi communication protocol, e.g., in a WLAN. Further, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some implementations, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between the electronic devices 110-1 and 110-2, and the access point 112.

In some implementations, the one or more radios 114 in electronic devices 110 also include GNSS radios (or receivers) configured to receive signals from a network of satellites orbiting Earth (e.g., GPS satellites, GLONASS satellites, Galileo satellites, and/or BeiDou satellites, among other GNSS satellites). The GNSS signals received by the radios 114 (and/or the information contained in these signals) can be communicated to other components of the devices 110 to effectuate the techniques described herein.

In some implementations, the access point 112 can group the electronic devices 110 into a target station set. The target station set concept comes from downlink multi-user transmission in which the access point 112 can transmit to multiple stations simultaneously in one Physical Layer Protocol Data Unit (PPDU) using Orthogonal Frequency Division Multiple Access (OFDMA) or multiuser (MU) Multiple Input Multiple Output (MU-MIMO). Here, the target station set is a set of stations that can simultaneously be served by the access point 112. The stations in the target station set do not need to share the same physical layer (PHY) parameters, such as modulation and coding scheme (MCS), number of streams, etc.

In some implementations, the access point 112 can simultaneously communicate with a plurality of electronic devices 110 using MU techniques, such as MU-MIMO. In some examples, the access point 112 communicates with the electronic devices 110 using frequency multiplexing, such that the access point 112 allocates each of the electronic devices a portion of the overall bandwidth. For example, to simultaneously communicate with four electronic devices over an 80 Megahertz (MHz) bandwidth, the access point 112 transmits a MU-PPDU over the 80 MHz bandwidth. The MU-PPDU includes a sub-PPDU for each of the four electronic devices, where each sub-PPDU (or sub-channel) is allocated 20 MHz. The access point 112 can use the MU-PPDU to communicate with devices in the same target set and/or devices in different target sets.

In some implementations, access point 112 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUs), which can be allocated to different electronic devices (users). Under the standard, the access point 112 coordinates multiuser OFDMA by broadcasting a trigger frame which, among other things, allocates a RU to each participating electronic device. Each electronic device responds to the trigger frame by transmitting a PPDU to the access point 112 using the allocated RU. The trigger frame can also include power control information. The access point 112 can instruct all electronic devices 110 when to start and stop transmitting. Note that access point 112 and the electronic devices 110 can communicate with one or more legacy electronic devices that are not compatible with the IEEE 802.11 standard (i.e., that do not use multi-user trigger-based channel access).

In some implementations, processing a packet or frame in one of the electronic devices 110 and/or the access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of electronic devices 110 and access point 112 can communicate with each other. Notably, access point 112 can transmit a PPDU that includes a preamble and a data field. In some implementations, access point 112 can be configured to use concatenated PPDUs (C-PPDUs), e.g., for low latency communications with receiver stations. A C-PPDU includes a plurality of component PPDUs, each of which includes preamble and a data payload. As described in more detail below, the C-PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the access point 112 might not perform contention or receive a block acknowledgement (BA) before the plurality of component PPDUs are transmitted.

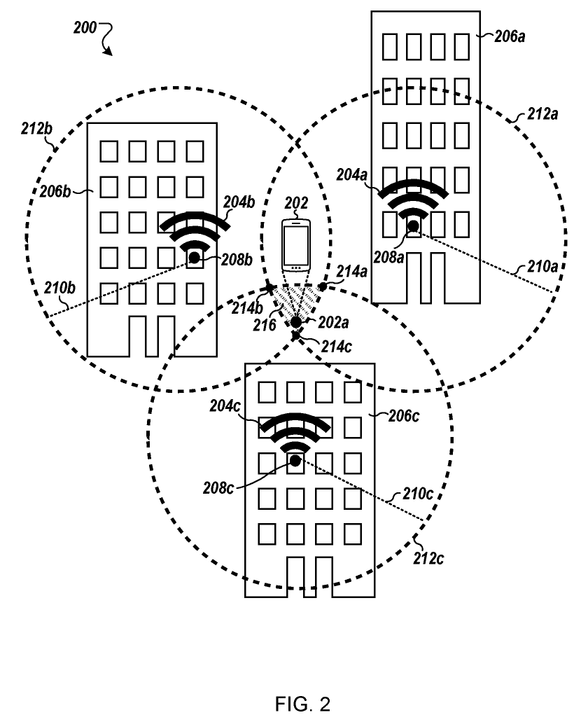

Referring to FIG. 2, an example of Wi-Fi positioning is shown, according to some implementations. In this example, an environment 200 includes a wireless device 202 at position 202a and three wireless access points (APs) 204a, 204b, 204c disposed within buildings 206a, 206b, 206c, respectively.

As illustrated, each of the APs 204a, 204b, 204c is associated with a respective centroid 208a, 208b, 208c and a radius 210a, 210b, 210c. In general, a centroid 208a, 208b, 208c can represent the geographical location of the respective AP 204a, 204b, 204c. For example, a centroid 208a, 208b, 208c can be a set of two dimensional (2D) coordinates (e.g., X, Y) or three dimensional (3D) coordinates (e.g., X, Y, Z) for the respective AP 204a, 204b, 204c. In some examples, the coordinates can correspond to the latitude, longitude, and altitude of the AP 204a, 204b, 204c. In some examples, centroids 208a, 208b, 208c are known (e.g., surveyed) or learned, e.g., through crowdsourced measurements. For example, during a harvesting phase, each AP 204a, 204b, 204c can transmit a wireless signal at one or more set intervals. A wireless device can receive the wireless signal, measure the received signal strength indicator (RSSI) of the signal, and transmit the RSSI along with its current position (e.g., X, Y, Z coordinates) to a radio map server (not shown) for storage in a radio map database (e.g., database 506). After multiple measurements (e.g., hundreds or thousands) are gathered for each AP 204a, 204b, 204c at different positions and under different conditions, the measurements can be processed (e.g., by the radio map server) using, for example, a weighted centroid algorithm, to determine the centroids 208a, 208b, 208c. Once calculated, each of the centroids 208a, 208b, 208c can be stored (e.g., in the radio map database) in association with the respective AP 204a, 204b, 204c, such as in a dataset with the MAC address of the AP, for subsequent use in positioning.

In some examples, radius 210a, 210b, 210c can represent the radius of influence for the respective AP 204a, 204b, 204c, or the effective range within which devices can connect to the AP and maintain a usable signal. As shown in FIG. 2, each radius 210a, 210b, 210c extends from a centroid 208a, 208b, 208c of the respective AP 204a, 204b, 204c, thereby establishing a coverage region 212a, 212b, 212c for the respective AP 204a, 204b, 204c (e.g., a 2D or 3D geographical region in which the AP can effectively provide wireless network service and/or in which the device 202 is located). In some examples, radii 210a, 210b, 210c can depend on one or more factors, such as the frequency band of the AP, the output power of the AP, and/or the AP antenna type, among others. In some examples, radii 210a, 210b, 210c can be determined based in part on a strength of a signal (e.g., RSSI) received by the device 202 from the respective AP 204a, 204b, 204c, such as by processing the RSSI with the aforementioned crowdsourced measurements to determine a likely radius from the centroid of the respective AP that the device is within. In some examples, the radii are assumed to be fixed about the centroids such that the regions 212a, 212b, 212c are generally circular or spherical. In some examples, each radius can vary according to, for example, a radiation pattern of the AP, or known interference or obstructions at the AP, among other factors. In some examples, the radii 210a, 210b, 210c can be stored (e.g., in the radio map database) in association with the respective AP 204a, 204b, 204c, such as in a dataset with the MAC address of the AP (and the centroid), for subsequent use in positioning. In some examples, the radii 210a, 210b, 210c are known to the device 202.

When determining the position of the device 202 using Wi-Fi positioning, the device 202 can first perform a scan (e.g., a Wi-Fi scan) to detect signals from one or more APs in its vicinity (or proximity or communication range). In some examples, detecting the APs can include detecting an identifier (e.g., MAC address) for respective APs. In some examples, the device 202 can also measure a strength of the signal received from respective APs, such as an RSSI of the signal. In this example, the device 202 detects APs 204a, 204b, 204c. Once detected, the device 202 retrieves (e.g., from the radio map database) the centroids 208a, 208b, 208c (e.g., the coordinates) for the APs 204a, 204b, 204c and, in some examples, the radii 210a, 210b, 210 for the APs 204a, 204b, 204c. In some examples, the device 202 requests the centroids 208a, 208b, 208c and/or radii 210a, 210b, 210c using the identifiers (e.g., MAC addresses) and/or RSSI identified in the scan. In some examples, the device 202 receives one or more map tiles that include centroids and/or radii information corresponding to one or more APs for a geographic region (e.g., 1 square mile) in which the device is located.

In some examples, to determine its position, the device 202 identifies one or more geometric intersections among the radii 210a, 210b, 210c from the centroids 208a, 208b, 208c of the detected APs 204a, 204b, 204c. In other words, the device 202 can identify one or more geometric intersections among the regions 212a, 212b, 212c. In this example, the device 202 identifies intersections 214a, 214b, and 214c. Based on this information, the device 202 determines that its position is within a region 216 that is bounded by intersections 214a, 214b, and 214c. The device 202 can then estimate its position by, for example, determining the centroid of the intersections 214a, 214b, and 214c. This position can be expressed in geographical coordinates using the known location of the centroids 208a, 208b, 208c and the known radii 210a, 210b, 210c. The estimated position (e.g., the centroid of the intersections 214a, 214b, and 214c) may not correspond to the true position 202a of the device 202, and thus may be erroneous. In some examples, the device 202 can also determine a measure of uncertainty for the position estimate, which can be based, e.g., on a size of the region 216.

Note that although the positioning determination is described from the perspective of the device 202, one or more of the positioning operations can be performed by another device, such as a remote server or separate device, in some examples. For example, the device 202 can send information regarding the detected APs 204a, 204b, 204c (e.g., the MAC addresses, measured RSSI) to a remote server (not shown), and the remote server can perform operations to determine the position of the device 202 and return the position to the device.

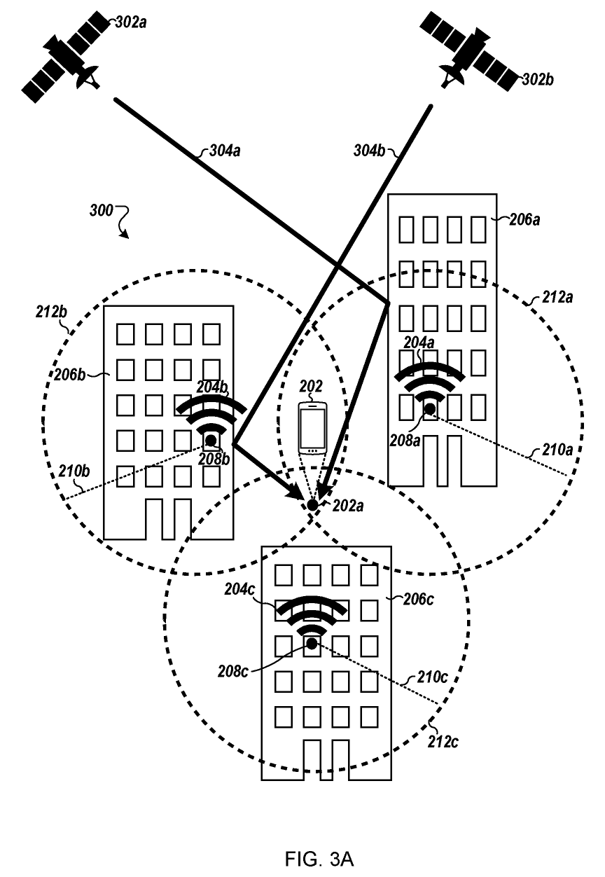

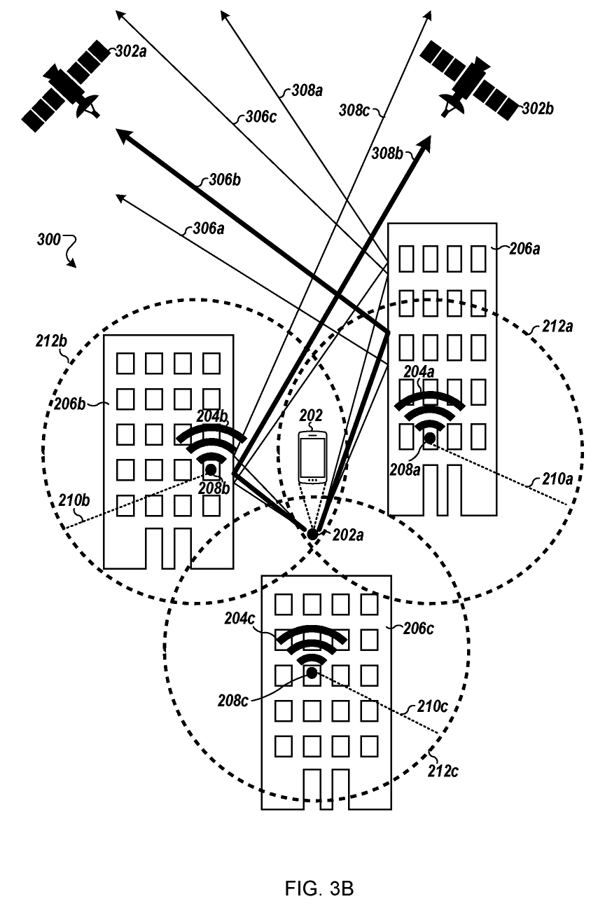

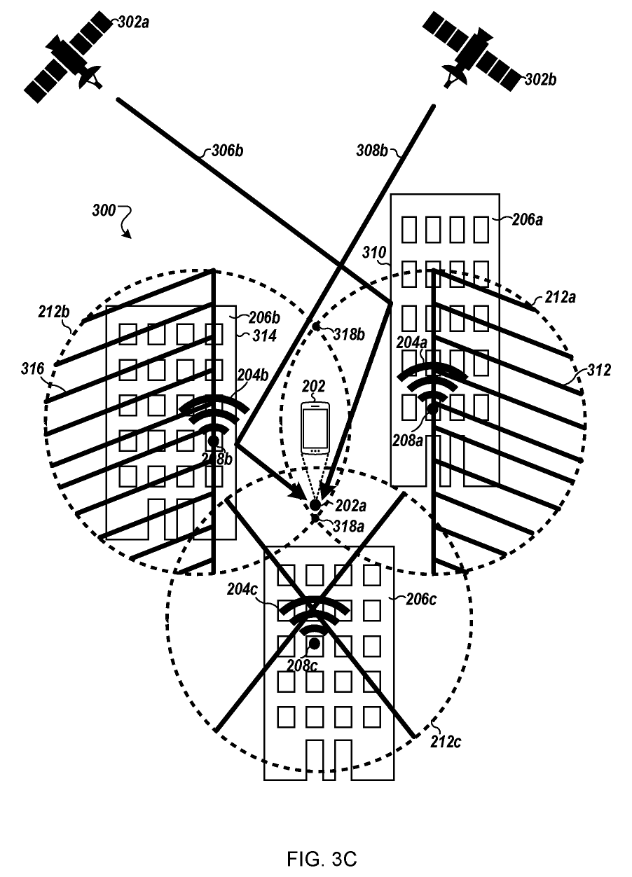

As illustrated in the foregoing example, a position estimate determined using Wi-Fi centroids can result in positioning errors and high positioning uncertainty. To improve Wi-Fi positioning (and other types of positioning), GNSS ray tracing can be additionally or alternately used, as described herein. Referring to FIG. 3A, an example of Wi-Fi positioning with GNSS ray tracing is shown, according to some implementations. In this example, an environment 300 includes a wireless device 202 at position 202a and three APs 204a, 204b, 204c disposed within buildings 206a, 206b, 206c, respectively. Environment 300 also includes GNSS satellites 302a, 302b in orbit above device 202. In an example, environment 300 can be the same or similar to environment 200 shown in FIG. 2, and elements of environment 300 having like reference numbers are described with reference to FIG. 2.

As shown in FIG. 3A, device 202 receives signals 304a, 304b from GNSS satellites 302a, 302b, respectively. Signals 304a, 304b can include information about the position of the GNSS satellites 302a, 302b (e.g., ephemeris data), among other information. However, the device 202 may not know the exact path taken by the signals 304a, 304b to reach the device 202, or whether such signal paths were line of sight signal paths or included one or more reflections. In this example, the device 202 may not know that the signals 304a, 304b reflected off the buildings 206a, 206b, respectively, or where (e.g., which facet of the buildings 206a, 206b) such reflections occurred. Knowledge of the signal paths 304a, 304b and their reflections can provide useful context for improving Wi-Fi positioning.

In order to identify the likely signal path of the signals 304a, 304b, the device 202 can utilize ray tracing. For example, referring to FIG. 3B, the device 202 generates a set of simulated ray traces 306a, 306b, 306c that originate at a position of the device 202 and reflect off at least one modeled object (e.g., at least one of buildings 206a, 206b, 206c). The device 202 can then analyze the generated ray traces 306a, 306b, 306c to determine whether any of these ray traces arrives at the position of GNSS satellite 302a. Similarly, the device 202 can generate a set of simulated ray traces 308a, 308b, 308c that originate at a position of the device 202 and reflect off of at least one modeled object, and can determine whether any of these ray traces arrives at the position of GNSS satellite 302b. Although three ray traces are generated for each GNSS satellite 302a, 302b in this example, fewer (e.g., 1 or 2) or additional ray traces can be generated in some examples.

To generate the ray traces, the device 202 can obtain an estimate of its current position, which can be an estimate determined from Wi-Fi positioning, dead reckoning, or by other means. The device can also obtain building model data that describes the 3D geometry and position/location of buildings 206a, 206b, 206c and other infrastructure within a vicinity of the device. In some examples, the building model data (which may be separate from or included in the map tile data described herein) can be obtained from a database (e.g., database 506). Using the estimated position and the building model data, the device 202 generates a set of ray traces that originate at its estimated position. One or more of the ray traces may reflect off of at least one of the objects represented in the building model data. For example, to generate the ray trace 306a, the device 202 can model propagation of the GNSS signal in an open air medium at a particular angle from the estimated device position toward the building 206a. When the ray trace 306a reaches the building 206a, the device 202 can model the reflection of the GNSS signal based on, for example, any/all of the angle of incidence, the geometry of the incident building surface, and the reflectivity of the surface (if available). Once the reflection is modeled, the device 202 can continue to model propagation of the GNSS signal toward the GNSS satellite 302a, accounting for any further reflections and/or changes in the propagation medium as needed. A similar process can be used to generate one or more other ray traces, with modulations in the initial angle from the device 202.

If a ray trace arrives at the position of a GNSS satellite, it is considered a successful ray tracing solution that accurately represents the signal path of a signal from that GNSS satellite. In this example, ray traces 306b and 308b arrive at the position of GNSS satellites 302a, 302b, respectively, and thus are considered successful solutions that represent the respective signal paths of signals 304a, 304b. In some instances, a ray trace can be a direct line of sight path that does not include any reflections. When a successful ray trace is identified, the context it provides can be used to improve device positioning. For example, instead of considering the position of the device to be anywhere within an AP's coverage radius, a successful ray trace allows for a more informed estimate of where within that radius the device is located, thereby reducing uncertainty. In some examples, the ray trace can help exclude an AP from consideration during positioning, such as if the AP is determined to be too far away from the device based on the reflection data. This focuses the positioning estimate more accurately on one or more remaining APs. Similarly, the ray trace can help include an AP from consideration during positioning, such as if the AP is determined to be close to or otherwise indicative of the device’s position based on the reflection data. In some other implementations, the ray tracing techniques can be used to improve the accuracy of GNSS-only location determination, e.g., by increasing the number of satellites that can be used to derive a position. In still other examples, the ray tracing techniques and resulting GNSS data can be used in conjunction with one or more other techniques for location determination to refine a location estimate.

Referring to FIG. 3C, an example of improving Wi-Fi positioning with GNSS ray tracing is shown. In this example, successful ray trace 306b includes a reflection off of a facet 310 of building 206a, which suggests that the signal 304a also reflected off of the facet 310 and arrived at the device 202 from the direction of the facet 310 after reflection. This context provides strong evidence that the device 202 is positioned adjacent to (e.g., on the reflective side of) facet 310, as opposed to beyond facet 310 or adjacent to another facet of building 206a. As such, a portion 312 of the radius 210a that is beyond facet 310 can be removed from consideration when determining the position of device 202, effectively reducing the zone of uncertainty for AP 204a. Similarly, successful ray trace 308b includes a reflection off of a facet 314 of building 206b, which suggests that the signal 304b also reflected off of the facet 314 and arrived at the device from the direction of the facet 314 after reflection. This context provides strong evidence that the device 202 is positioned adjacent to (e.g., on the reflective side of) facet 314, as opposed to beyond facet 314 or adjacent to another facet of building 206b. As such, a portion 316 of the radius 210b that is beyond facet 314 can be removed from consideration when determining the position of device 202, effectively reducing the zone of uncertainty for AP 204b. Based on the context for the position of device 202 provided by ray traces 306b, 308b (e.g., ray trace 306b indicating that the device 202 is adjacent to facet 310, and/or ray trace 308b indicating that the device is adjacent to facet 314), AP 204c can be excluded from consideration during positioning (as indicated by crossed out region 212c), thereby enabling the positioning estimate to focus on APs 204a, 204b for positioning. Note that the direction of ray traces 306b, 308b have been reversed in FIG. 3C to align with the direction of signals 304a, 304b.

Using the foregoing context from the ray traces 308a, 308b, the device 202 can determine its position by identifying one or more geometric intersections among the adjusted radii 210a, 210b from the centroids 208a, 208b of the detected APs 204a, 204b. In other words, the device 202 can identify one or more geometric intersections among the adjusted region 212a (e.g., the region 212a with portion 312 removed) and adjusted region 212b (e.g., the region 212b with portion 316 removed). In this example, the device 202 identifies intersections 318a and 318b. Based on the context from the ray traces 308a, 308b, such as the direction and/or angle of arrival off of facets 310, 314), the device 202 can determine that the intersection 318b corresponds to its position. This position can be expressed in geographical coordinates using the known location of the centroids 208a, 208b and the known radii 210a, 210b. Notably, this estimated position (e.g., the position of intersection 318b) substantially corresponds the true position 202a of the device 202, and thus has a lower error than the position estimated based solely on Wi-Fi (as discussed with reference to FIG. 2). In some examples, the device 202 can also determine a measure of uncertainty for the position estimate.

Note that although the positioning determination is described from the perspective of the device 202, one or more of the positioning operations can be performed by another device, such as a remote server, in some examples. For example, the device 202 can send information regarding the detected APs 204a, 204b, 204c (e.g., the MAC addresses, measured RSSI) and/or the received signals 304a, 304b to a remote server (not shown), and the remote server can perform operations to generate the ray traces, determine the position 202a of the device 202, and return the position 202a to the device.

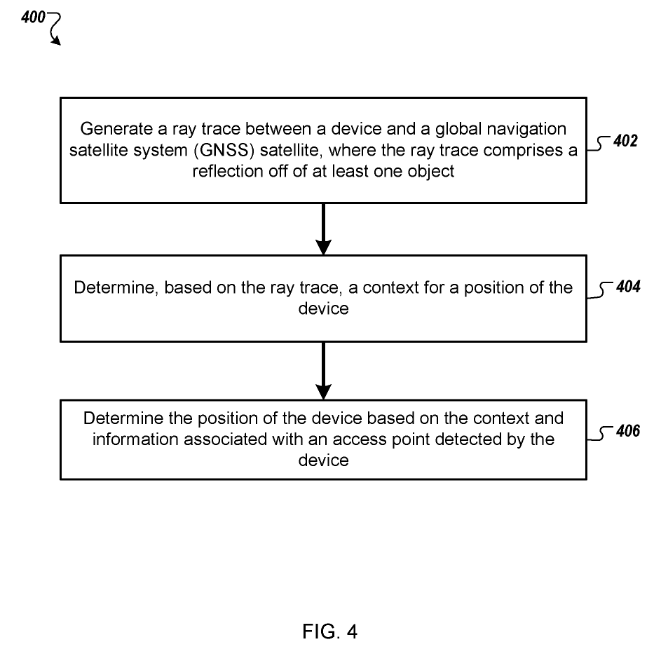

FIG. 4 illustrates a flowchart of an example method 400, according to some implementations. For clarity of presentation, the description that follows generally describes method 400 in the context of the other figures in this description. For example, method 400 can be performed by devices 110 of FIG. 1. It will be understood that method 400 can be performed, for example, by any suitable system(s), environment(s), software, and/or hardware. In some implementations, various steps of method 400 can be run in parallel, in combination, in loops, or in any order.

Operations of the method include generating (402) a ray trace between a device (e.g., the device 202) and GNSS satellite (e.g., GNSS satellites 302a, 302b). The ray trace can include a reflection off of at least one object, such as a building (e.g., buildings 206a, 206b, 206c) or other modeled infrastructure . Based on the ray trace, a context for a position of the device is determined (404). Such a context can include, but is not limited to, a point of a reflection of a signal from the GNSS satellite off of the at least one object, a surface of the at least one object associated with a reflection of the signal from the GNSS satellite, and/or a direction of arrival of the signal from the GNSS satellite at the device. At 406, the position of the device is determined based at least on the context and information (e.g., centroid information, radius information, and/or RSSI, among other information) associated with an AP detected by the device.

FIG. 5 illustrates a block diagram of an electronic device 500, according to some implementations. The electronic device 500 can be a cellular telephone, a smartwatch, an access point, a wireless speaker, an Internet-of-Things (IoT) device, among other examples. The electronic device 500 includes hardware resources 502 that include one or more processors (or processor cores) 510, one or more memory/storage devices 520, and one or more communication resources 530, each of which can be communicatively coupled via a bus 540.

The one or more processors 510 include one or more devices configured to perform computational operations. For example, the one or more processors 510 can include one or more microprocessors, application-specific integrated circuits (ASICs), microcontrollers, graphics processing units (GPUs), programmable-logic devices, and/or one or more digital signal processors (DSPs). The processors 510 can include, for example, a processor 512 and a processor 514. The processor(s) 510 can be, for example, a central processing unit (CPU), a reduced instruction set computing (RISC) processor, a complex instruction set computing (CISC) processor, a graphics processing unit (GPU), a DSP such as a baseband processor, an ASIC, a field-programmable gate array (FPGA), a radio-frequency integrated circuit (RFIC), and/or another processor (including those discussed herein).

The memory/storage devices 520 can include main memory and/or disk storage. The memory/storage devices 520 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 520 are coupled to one or more high-capacity mass-storage devices (not shown). In some examples, memory/storage devices 520 can be coupled to a magnetic or optical drive, a solid-state drive, or another type of mass-storage device. In these examples, the memory/storage devices 520 can be used by electronic device 500 as fast-access storage for often-used data, while the mass-storage device is used to store less frequently used data.

The communication resources 530 can include interconnection or network interface components or other suitable devices to communicate with one or more peripheral devices 504 or one or more databases 506 via a network 508. For example, the communication resources 530 can include wired communication components (e.g., for coupling via universal serial bus (USB)), cellular communication components, NFC components, Bluetooth® (or Bluetooth® Low Energy) components, Wi-Fi® components, and other communication components.

The communication resources 530 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 500 includes one or more nodes, e.g., a pad or a connector, which can be coupled to the set of antennas. Thus, electronic device 500 might or might not include the set of antennas. For example, communication resources 530 can include a Bluetooth™ networking system, a cellular networking system (e.g., a 3G/4G/5G/6G network such as UMTS, LTE, etc.), a USB networking system, a networking system based on the standards described in IEEE 802.11 (e.g., a Wi-Fi® networking system), an Ethernet networking system, and/or another networking system.

In some implementations, communication resources 530 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 530 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 550 can include software, a program, an application, an applet, an app, or other executable code for causing at least any of the processors 510 to perform any one or more of the methodologies discussed herein. The instructions 550 can reside, completely or partially, within at least one of the processors 510 (e.g., within the processor’s cache memory) and/or the memory/storage devices 520. In some implementations, any portion of the instructions 550 can be transferred to the hardware resources 502 from the peripheral devices 504 and/or the databases 506. Accordingly, the memory of processors 510, the memory/storage devices 520, the peripheral devices 504, and the databases 506 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware and/or software. For example, at least some of the operations in the communication techniques can be implemented using instructions 550, operating system (such as a driver for an interface circuit in communication resources 530) or in firmware in an interface circuit in communication resources 530. Additionally or alternatively, at least some of the operations in the communication techniques can be implemented in a physical layer, such as hardware in an interface circuit in communication resources 530. In some implementations, the communication techniques are implemented, at least in part, in a MAC layer and/or in a physical layer in an interface circuit in communication resources 530.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service, by LTE, 5G, or any other communication system.

Although specific components are used to describe electronic device 500, in some implementations, different components and/or subsystems can be present in electronic device 500. For example, electronic device 500 can include one or more additional processing subsystems, memory subsystems, networking subsystems, and/or display subsystems. Additionally, one or more of the subsystems might not be present in electronic device 500. In some implementations, electronic device 500 can include one or more additional subsystems that are not shown in FIG. 5. In some implementations, electronic device can include an analysis subsystem that performs at least some of the operations in the communication techniques. Although separate subsystems are shown in FIG. 5, in some implementations some or all of a given subsystem or component can be integrated into one or more of the other subsystems or component(s) in electronic device 500.

For one or more embodiments, at least one of the components set forth in one or more of the preceding figures may be configured to perform one or more operations, techniques, processes, or methods as set forth in the example section below. For example, the circuitry as described above in connection with one or more of the preceding figures may be configured to operate in accordance with one or more of the examples set forth below. For another example, circuitry associated with a device, access point, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent in view of the disclosure. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
generating a ray trace between a device and a global navigation satellite system (GNSS) satellite, wherein the ray trace comprises a reflection off of at least one object;
determining, based on the ray trace, a context for a position of the device; and
determining the position of the device based at least on the context and information associated with an access point (AP) detected by the device.

2. The method of claim 1, further comprising:
receiving an estimated position of the device;
accessing object data specifying one or more objects within a predetermined distance of the estimated position of the device;
generating a plurality of ray traces from the estimated position of the device to a GNSS satellite, wherein each of the plurality of ray traces reflects off of at least one of the one or more objects; and
selecting, from the plurality of ray traces, the ray trace that connects the device and the GNSS satellite.

3. The method of claim 2, wherein the estimated position of the device is based at least on the information associated with the AP.

4. The method of claim 2, further comprising:
determining a position of the GNSS satellite; and
selecting the ray trace that connects the device and the GNSS satellite by selecting, from the plurality of ray traces, a ray trace connecting the estimated position of the device and the position of the satellite.

5. The method of claim 4, wherein the position of the GNSS satellite is determined from a signal received from the GNSS satellite.

6. The method of claim 2, wherein the object data comprises three-dimensional building data, and wherein at least one of the one or more objects comprises a building or infrastructure.

7. The method of claim 1, wherein the ray trace represents a signal path of a signal received by the device from the GNSS satellite.

8. The method of claim 1, wherein the context comprises at least one of:
a point of a reflection of a signal from the GNSS satellite off of the at least one object,
a surface of the at least one object associated with a reflection of the signal from the GNSS satellite, or
a direction of arrival of the signal from the GNSS satellite at the device.

9. The method of claim 1, further comprising:
receiving position data specifying a position of the AP; and
determining the position of the device based at least on the context and the position of the AP.

10. The method of claim 1, wherein the AP is associated with a region representing a possible position of the device, the method comprising:
adjusting, based on the context, the region associated with the AP; and
determining the position of the device based at least on the context and the adjusted region.

11. The method of claim 10, wherein the region comprises a region defined by a radius surrounding a centroid associated with the AP.

12. The method of claim 11, wherein the radius is determined based on a strength of a signal received by the device from the AP.

13. The method of claim 10, wherein adjusting the region comprises removing at least a portion of the region.

14. The method of claim 13, wherein the context comprises a surface of the at least one object associated with the reflection, and wherein the at least the portion of the region is removed based on the surface.

15. The method of claim 10, further comprising:
excluding, based on the context, a region associated with at least one other AP when determining the position of the device.

16. The method of claim 10, further comprising:
including, based on the context, a region associated with at least one other AP when determining the position of the device.

17. The method of claim 10, further comprising:
identifying a surface of the at least one object associated with the reflection; and
removing at least a portion of the region based on the surface.

18. The method of claim 10, wherein determining the position of the device based at least on the context and the adjusted region comprises determining the position of the device within the adjusted region.

19. A non-transitory computer-readable storage medium encoded with instructions that, when executed by one or more processors, cause the one or more processors to perform operations comprising:
generating a ray trace between a device and a global navigation satellite system (GNSS) satellite, wherein the ray trace comprises a reflection off of at least one object;
determining, based on the ray trace, a context for a position of the device; and
determining the position of the device based at least on the context and information associated with an access point (AP) detected by the device.

20. A device, comprising:
one or more processors; and
one or more storage devices storing instructions executable by the one or more processors to:
generate a ray trace between the device and a global navigation satellite system (GNSS) satellite, wherein the ray trace comprises a reflection off of at least one object;
determine, based on the ray trace, a context for a position of the device; and
determine the position of the device based at least on the context and information associated with an access point (AP) detected by the device.
